(19) United States
(12) Patent Application Publication
(10) Pub. No.: US 2006/0202793 A1
(43) Pub. Date: Sep. 14, 2006

(54) Image sensor device and manufacturing method of the same

(75) Inventor: Toshitaka Akahoshi, Kyoto (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/373,255

(22) Filed: Mar. 13, 2006

(30) Foreign Application Priority Data
Mar. 14, 2005 (JP) 2005-070186

(51) Int. Cl. H01C 7/00

(52) U.S. Cl. 338/34

(57) ABSTRACT

A metal exposing portion (12) exposed from a surface of a base (2) between an internal terminal portion (8) and an external terminal portion (9) is formed in a metal wiring (7) embedded in the base (2). Accordingly, in a case where a solder ball is not mounted on the external terminal portion (9), although a bled component flows from sealing resin along the upper surface of the base (2) during a manufacturing method, the bled component stops by the metal exposing portion (12) which function as a breakwater and thus the bled component can be prevented from covering the external terminal portion (9).

### BACKGROUND OF THE INVENTION

1. Field of the Invention

The present invention relates to an image sensor device in which an image sensor such as a charge coupled device (CCD) is mounted on a base and a manufacturing method of the same.

2. Description of the Related Art

An image sensor device is widely used in a video camera, a still camera, or a mobile phone. For example, as disclosed in Japanese Unexamined Patent Application Publication No. 2003-352082 or Japanese Unexamined Patent Application Publication No. 2002-299595, the image sensor device is provided as in a package form in which an image sensor such a charge coupled device (CCD) is mounted on a base and a light receiving region is covered by a light transmission plate. In order to miniaturize the image sensor device, the image sensor is mounted on the base in a bare chip form. This conventional image sensor device will be described with reference to FIG. 12.

FIG. 12 is a cross-sectional view illustrating a structure of the conventional image sensor device. As illustrated in FIG. 12, the image sensor device includes a frame-shaped base 101 made of an insulating material such as epoxy resin and having an opening 100 at its center, an image sensor 102 attached to one surface, for example, a lower surface of the base 101, a window member 103 which is attached to the other surface, for example, an upper surface of the base 101 to face the image sensor 102 through the opening 100 and is made of a light transmission material such as glass, and a solder ball 104.

In addition, the periphery of the image sensor 102 and an interval between the image sensor 102 and the base 101 are filled with sealing resin 105.

A metal wiring 106 is embedded in the base 101. One end of the metal wiring 106 is an internal terminal portion 107 exposed from mold resin composing the base 101 in the vicinity of the opening 100 of the lower surface of the base 101, and the other end of the wiring 106 is an external terminal portion 108 exposed from the mold resin composing the base 101 at an outer edge of the lower surface of the base.

However, in the conventional image sensor device, the following improvements must be accomplished in terms of miniaturization and slimness. First, its background will be described.

Since an electronic device which attaches importance to portability, such as a mobile phone, requires miniaturization or slimness in its market. For example, a concave portion is formed in a component mounting board of the electronic device and the image sensor 102 of the image sensor device is received in the concave portion. In this case, in the structure illustrated in FIG. 12, the slimness cannot be accomplished due to the solder ball 104 mounted on the external terminal portion 108 of the image sensor device. Accordingly, in order to address this problem, an image sensor device without the solder ball 104 is considered.

However, in case that the solder ball 104 is not mounted on the conventional image sensor device according to the request for the slimness of the electronic device, when the sealing resin 105 filled as a reinforcement material of the image sensor 102 is coated, a low molecular component or the like contained in the sealing resin 105 is leaked and spread, that is, a bleed phenomenon occurs. In this case, a surface 101a of the base 101 at the side of the image sensor and a surface 108a of the external terminal portion 108 exposed from the base 101 are in the same plane and thus the low molecular component which flows along the surface 101a of the base 101 may cover a portion of the surface 108a of the external terminal portion 108. When the bleed phenomenon occurs, a connection region of the external terminal portion 108 is reduced and thus mounting yield of the electronic device is reduced. Further, mounting reliability is decreased.

Furthermore, in case that this structure is employed, only the surface 108a of the external terminal portion 108 is externally exposed from the surface of the image sensor device as the wiring 106 having good heat radiation. Accordingly, in the electronic device or the image sensor 102 which requires high heat radiation, it is difficult to obtain sufficient heat radiation characteristics.

### SUMMARY OF THE INVENTION

Accordingly, it is an object of the present invention to provide an image sensor device and a manufacturing method of the same, which is capable of preventing mounting yield or mounting reliability from being reduced and has good productivity and high heat radiation characteristics while realizing miniaturization and slimness of an electronic device.

In order to solve the conventional problem, an image sensor device and a manufacturing method of the same according to the present invention have the following features.

According to the present invention, there is provided an image sensor device including a base made of an insulating material and having an opening inside thereof; a metal wiring embedded in the base; an internal terminal portion formed in the metal wiring to be exposed from one surface of the base in proximity to the opening; an external terminal portion formed in the metal wiring to be exposed from one surface of the base in proximity to its outer circumference; an image sensor having a light receiving region and mounted on the one surface of the base to be connected to the internal terminal portion so that the light receiving region faces the opening; sealing resin filled in and covering the periphery of the image sensor and an interval between the image sensor and the base; and a window member attached to the other surface of the base and having light transmission, wherein the metal wiring is formed with a metal exposing portion exposed from the one surface of the base between the internal terminal portion and the external terminal portion.

By this structure, since the metal exposing portion exposed from one surface of the base between the internal terminal portion and the external terminal portion is formed, in a case where a solder ball is not mounted on the external terminal portion, although a bled component flows from the sealing resin along one surface of the base during a manufacturing method, the bled component stops by the metal exposing portion which functions as a breakwater and thus the bled component can be prevented from covering the external terminal portion and mounting yield or mounting reliability is not reduced when the image sensor device is mounted on an electronic device. Accordingly, it is possible to suppress the image sensor device from being enlarged due to the bleed phenomenon, to easily realize the miniaturization and the slimness of the image sensor device, and to obtain good mounting yield and mounting reliability. In addition, since the metal exposing portion as well as the external terminal portion is exposed, the exposure area of the metal wiring having good heat radiation on the base increases and thus high heat radiation characteristics can be obtained. Accordingly, it is possible to obtain sufficient heat radiation characteristics in an electronic device or an image sensor which requires high heat radiation.

In addition, in the image sensor device according to the present invention, the external terminal portion and the metal exposing portion may be protruded from the one surface of the base. By this structure, a bleed phenomenon can be more prevented as compared with a case where the metal exposing portion is in the same plane as one surface of the base and it is more difficult to cover the surface of the external terminal portion with the bled component, compared with a case where the metal terminal portion is in the same plane as one surface of the base. Accordingly, it is possible to more improve the mounting reliability.

Furthermore, in the image sensor device according to the present invention, the exposure surfaces of the external terminal portion and the metal exposing portion may be substantially in the same plane. By this structure, the metal exposing portion can be more easily used as a mounting reinforcement portion of the external terminal portion, compared with a case where exposure heights of the external terminal portion and the metal exposing portion are different from each other and thus it is possible to easily improve the mounting reliability when the image sensor device is mounted on an electronic device.

Moreover, in the image sensor device according to the present invention, a connection portion for connecting the external terminal portion with the metal exposing portion in the metal wiring may be exposed from the surface of the base. By this structure, the exposure area of the metal wiring on the surface of the base more increases by the exposure area of the connection portion, compared with a case where only the external terminal portion and the metal exposing portion are exposed and it is possible to obtain higher heat radiation characteristics.

In addition, in the image sensor device according to the present invention, the exposure surfaces of the external terminal portion and the metal exposing portion in the metal wiring may be substantially in the same plane as the one surface of the base.

Furthermore, according to the present invention, there is provided a method of manufacturing an image sensor device, which includes a step of using a pair of molds having cavities for forming a plurality of bases with resin, a metal thin lead in which a plurality of sets of metal wirings each having, in correspondence with the plurality of bases, an internal terminal portion, an external terminal portion, and a metal exposing portion therebetween, and a tape material having the metal thin lead, thereby to load the tape material between the pair of molds so that the sets of metal thin leads are arranged in regions corresponding to the plurality of bases in the cavities, and filling and curing sealing resin in the cavities thereby to form a molded product having a plurality of image sensor device forming regions corresponding to the bases respectively surrounding openings and the metal wirings having the internal terminal portion, the external terminal portion, and the metal exposing portion formed in each of the image sensor device forming regions; a step of dividing the molded product into a plurality of pieces; a step of mounting an image sensor at the side of the internal terminal portion comprised of the metal wirings of the molded product; a step of filling and covering sealing resin in the periphery of the image sensor and an interval between the image sensor and the molded product; and a step of attaching a window member made of a light transmitting material to the molded product at a surface opposite to a surface mounted with the image sensor. By this structure, it is possible to manufacture the image sensor device having the above-mentioned structure.

Moreover, in the method according to the present invention, the metal thin lead may be arranged so that a difference in thickness among the internal terminal portion, the external terminal portion, and the metal exposing portion in the metal wiring formed of the metal thin lead is absorbed utilizing deformation in a thickness direction of the tape material, and the sealing resin is filled in each of the cavities and cured. By this structure, it is possible to manufacture the image sensor device while absorbing the difference in the thickness between the internal terminal portion and the external terminal portion or the metal exposing portion in the metal wiring.

According to the present invention, there is provided a method of manufacturing an image sensor device including a step of using a pair of molds having cavities for forming a plurality of bases with resin, a metal thin lead in which a plurality of sets of metal wirings each having, in correspondence with the plurality of bases, an internal terminal portion and a metal exposing region formed at a location closer to the outer periphery of the metal wirings than the internal terminal portion, and a tape material having the metal thin lead for forming the plurality of sets of metal wirings corresponding to the plurality of bases, thereby to load the tape material between the pair of molds so that the sets of metal thin leads are arranged in regions corresponding to the plurality of bases in the cavities, and filling and curing sealing resin in the cavities thereby to form a molded product having a plurality of image sensor device forming regions corresponding to the bases respectively surrounding openings, and the internal terminal portion and the metal wirings in each of the image sensor device forming regions, each metal wirings having the metal exposing region formed to located at a peripheral portion of the image sensor device forming regions; a step of dividing the molded product into a plurality of pieces by using a cutting tool; a step of mounting an image sensor at the side of the internal terminal portion composed by each of the metal wirings of the molded product; a step of filling and covering sealing resin in the periphery of the image sensor and an interval between the image sensor and the molded product; and a step of attaching a window member made of a light transmission material to the molded product at a surface opposite to a surface of the molded product mounted with the image sensor, wherein the metal exposing region in the metal wirings is cut into halves by the cutting tool for use in dividing the molded product onto a plurality of pieces, whereby an external terminal portion and a metal exposing portion are formed in the metal wirings. By this structure, it is possible to manufacture the image sensor device in which a connection portion exposed between the external terminal portion and the metal exposing portion in the metal wiring is provided.

### BRIEF DESCRIPTION OF THE DRAWINGS

FIG. 1A is a cross-sectional view of an image sensor device according to a first embodiment of the present invention, and FIG. 1B is a bottom view of the image sensor device;

FIGS. 2A and 2B are partial cross-sectional views respectively illustrating steps in a method of manufacturing the image sensor device;

FIGS. 3A and 3B are partial cross-sectional views each illustrating a molding step in the method of manufacturing the image sensor device;

FIGS. 4A and 4B are partial cross-sectional views respectively illustrating the steps in the method of manufacturing the image sensor device;

FIGS. 5A and 5B are partial cross-sectional views respectively illustrating the steps in the method of manufacturing the image sensor device;

FIG. 6A is a cross-sectional view of an image sensor device according to a second embodiment of the present invention and FIG. 6B is a bottom view of the image sensor device;

FIGS. 7A and 7B are partial cross-sectional views respectively illustrating steps in a method of manufacturing the image sensor device;

FIGS. 8A and 8B are partial cross-sectional views each illustrating a molding step in the method of manufacturing the image sensor device;

FIGS. 9A and 9B are partial cross-sectional views respectively illustrating the steps in the method of manufacturing the image sensor device;

FIGS. 10A and 10B are partial cross-sectional views respectively illustrating the steps in the method of manufacturing the image sensor device;

FIG. 11A is a cross-sectional view of an image sensor device according to still another embodiment of the present invention and FIG. 11B is a bottom view of the image sensor device; and

FIG. 12 is a cross-sectional view of a conventional image sensor device.

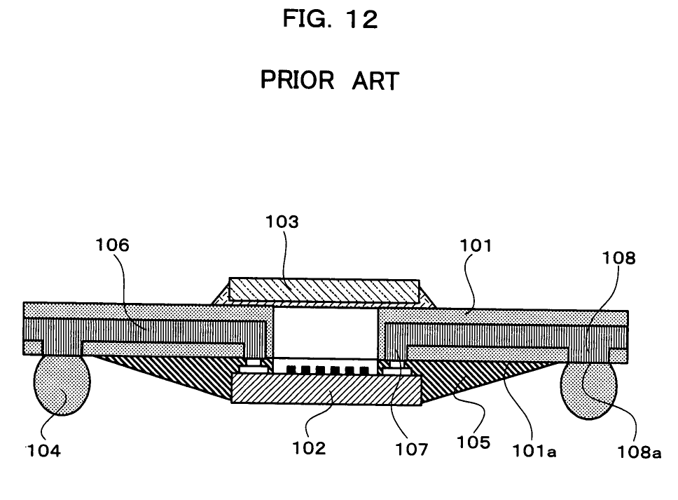

### DESCRIPTION OF THE PREFERRED EMBODIMENTS

Hereinafter, an image sensor device and a manufacturing method of the same according to embodiments of the present invention will be described in detail with reference to the accompanying drawings.

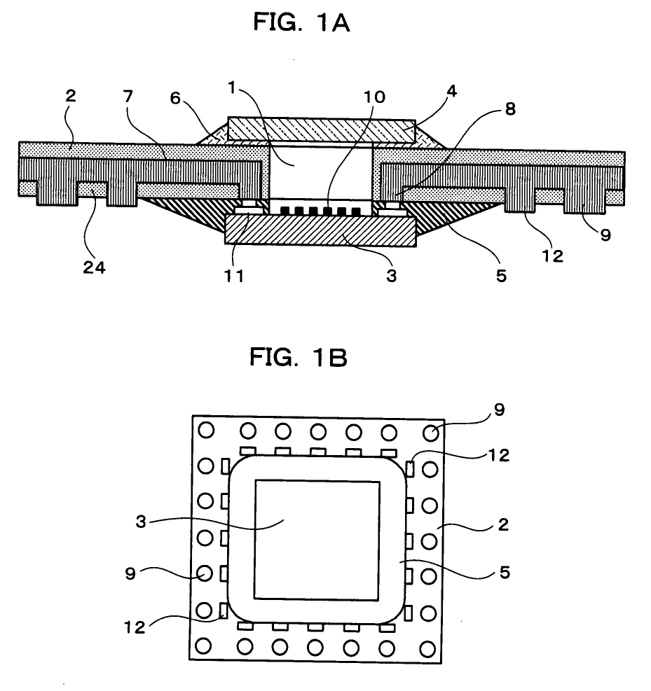

First, an image sensor device according to a first embodiment of the present invention will be described. FIG. 1A is a cross-sectional view of an image sensor device according to a first embodiment of the present invention and FIG. 1B is a bottom view of the image sensor device. In addition, in the below description, in order to facilitate understanding, a case where an image sensor is mounted on an upper surface of a base and a window member is mounted on a lower surface of the base will be described and shown. Furthermore, the window member and the image sensor need not be necessarily arranged at the upper and lower surfaces of the base, respectively, and may be positioned at any positions if the relative positions of the respective components are equal to one another.

As illustrated in FIGS. 1A and 1B, the image sensor device includes a base 2 made of an insulating material such as epoxy resin, having an opening 1 at its center, and having a frame shape and a substantially plane shape, an image sensor 3 attached to the upper surface of the base 2, and a window member 4 made of a light transmission material such as glass and attached to the lower surface of the base 2 to face the image sensor 3 through the opening 1.

In addition, the periphery of the image sensor 3 and an interval between the image sensor 3 and the base 2 are filled and covered with sealing resin 5. On the lower surface of the base 2, an interval between the base 2 and the window member 4 is sealed by sealing resin 6 provided at the periphery of the window member 4.

A metal wiring 7 is embedded in the base 2. One end of the metal wiring 7 is an internal terminal portion 8 exposed from mold resin 24 composing the base 2 in the vicinity of the opening 1 of the base and the other end of the wiring 7 is an external terminal portion 9 protruded from the mold resin 24 composing the base 2 in the vicinity of the outer circumference of the base.

The image sensor 3 is attached to the peripheral region of the opening 1 on the base 2 so that its light receiving region 10 is exposed to the opening 1. In the vicinity of the outer circumference of a surface of the image sensor 3 on which the light receiving area 10 is formed, an electrode pad for inputting/outputting an electrical signal between the image sensor 3 and an external device is provided, and the internal terminal portion 8 formed of the metal wiring 7 and the electrode pad are electrically connected to each other through a bump 11.

In addition, the metal wiring 7 is integrally formed with a metal exposing portion 12 exposed (exposed and protruded in this embodiment) from the upper surface of the base 2 between the internal terminal portion 8 and the external terminal portion 9. Here, in the present embodiment, the surface (protrusion section) of the metal exposing portion 12 and the surface (protrusion section) of the external terminal portion 9 are substantially in the same plane (have the same height).

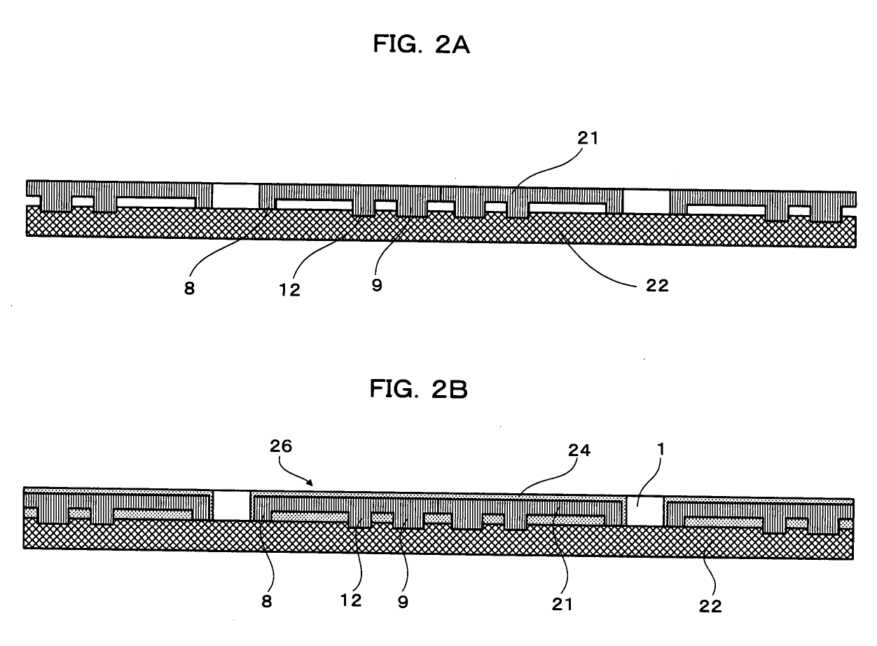

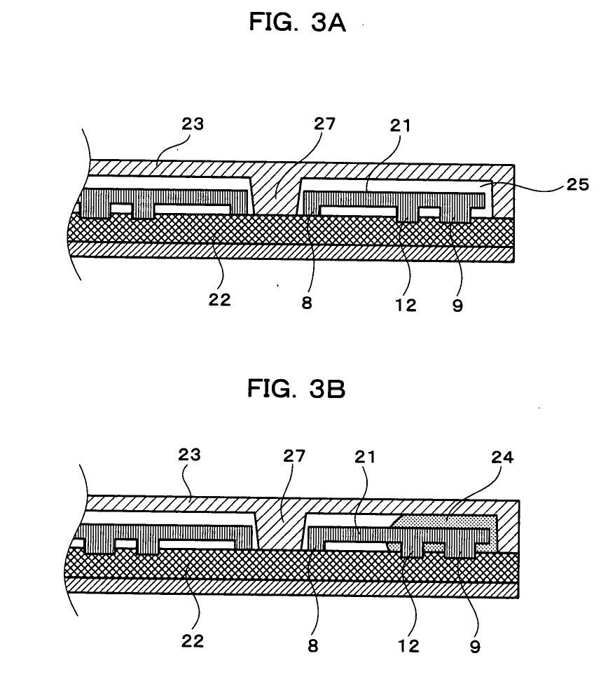

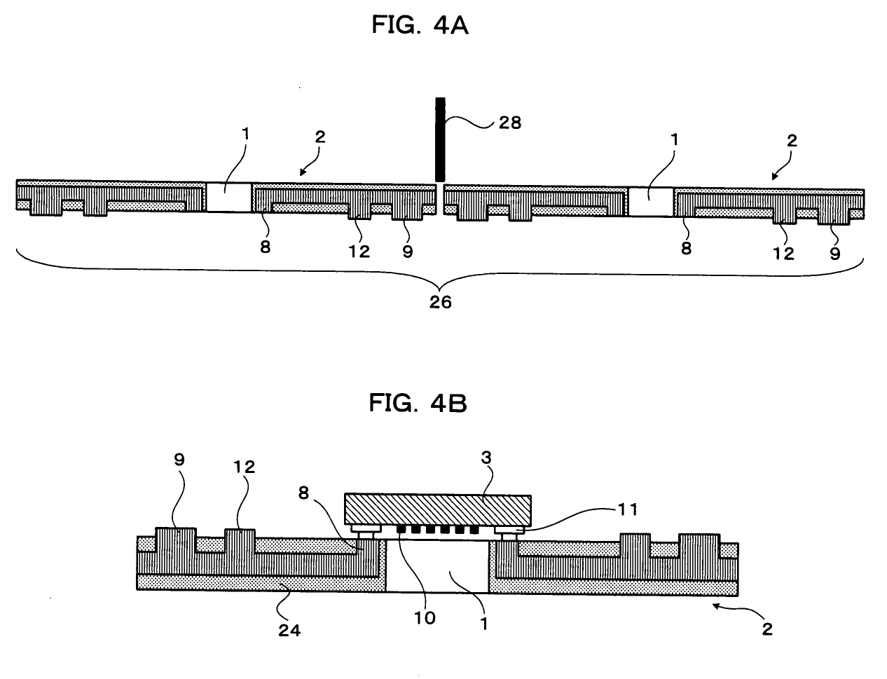

Next, a method of manufacturing the image sensor device will be described with reference to the accompanying drawings. FIGS. 2A, 2B, 4A, 4B, 5A, and 5B are partial cross-sectional views illustrating respective steps in the method of manufacturing the image sensor device. But, although, in the steps illustrated in FIGS. 2A, 2B, and 4A, only a region for forming two image sensor devices is illustrated, the manufacturing method is generally performed using a lead frame 21 in which a plurality of image sensor devices are provided in a grid shape. In addition, FIGS. 3A and 3B are cross-sectional views illustrating a molding step in the method of manufacturing the image sensor device.

First, as shown in FIG. 2A, the lead frame 21, in which a wiring pattern is formed, is laid on a sealing tape 22. The lower surface of the lead frame 21 is provided with concave portions by half etch or press and only portions, which will become the external terminal portion 9, the metal exposing portion 12, and the internal terminal portion 8, are protruded downward from the bottom surface of the concave portions. In this state, the lead frame 21 is laid on the sealing tape 22. In addition, the external terminal portion 9 and the metal exposing portion 12 is more protruded than the internal terminal portion 8 downward and the lead frame is laid on the sealing tape 22 by weighting so that a difference in a protrusion distance between the internal terminal portion 8 and the external terminal portion 9 or the metal exposing portion 12 is absorbed using deformation in a thickness direction of the sealing tape 22. For example, if the difference in the protrusion distance between the internal terminal portion 8 and the external terminal portion 9 or the metal exposing portion 12 is about 50 μm, the sealing tape 22 having an adhesive layer (not illustrated) having a thickness of about 50 μm is used. Thus, it is possible to ensure a deformation volume which can absorb the difference in the protrusion distance and to obtain a desired difference in the protrusion distance.

Next, in the step illustrated in FIG. 2B, a molding step is performed. In other words, as illustrated in FIGS. 3A and 3B, the lead frame 21 attached to the sealing tape 22 is mounted on a mold die 23 and mold resin 24 such as epoxy resin is filled in a die cavity 25 of the mold die 23 to embed the mold resin 24 in portions except the internal terminal portion 8, the external terminal portion 9, and the metal exposing portion 12 of the lead frame 21, thereby forming a molded product 26. Since the mold die 23 is formed with a barrier portion 27 for discriminating between cavities and the barrier portion 27 is not filled with the mold resin 24, the center of a region of the molded product 26 in which the image sensor device is formed (referred to as an image sensor device forming region) is formed with the opening 1, in the vicinity of which the image sensor 3 will be attached.

Next, as illustrated in FIG. 4A, the sealing tape 22 is stripped from the molded product 26 and the barrier portion between the adjacent image sensor device forming regions of the molded product 26 is then cut by a blade (cut jig) 28, thereby forming the base 2 of the image sensor device from the molded product 26. At this time, the internal terminal portion 8, the metal exposing portion 12, and the external terminal portion 9 are exposed from the surface of the base 2 and the other portions of the metal wiring 7 for connecting the above-mentioned portions with one another are embedded in the base 2.

Next, as illustrated in FIG. 4B, the image sensor 3 is mounted on the reversed base 2 in the state that its light receiving region 10 is downward. At this time, the electrode pad on the image sensor 3 is provided with the bump 11 and the bump 11 is connected to the internal terminal portion 8 on the corresponding base 2.

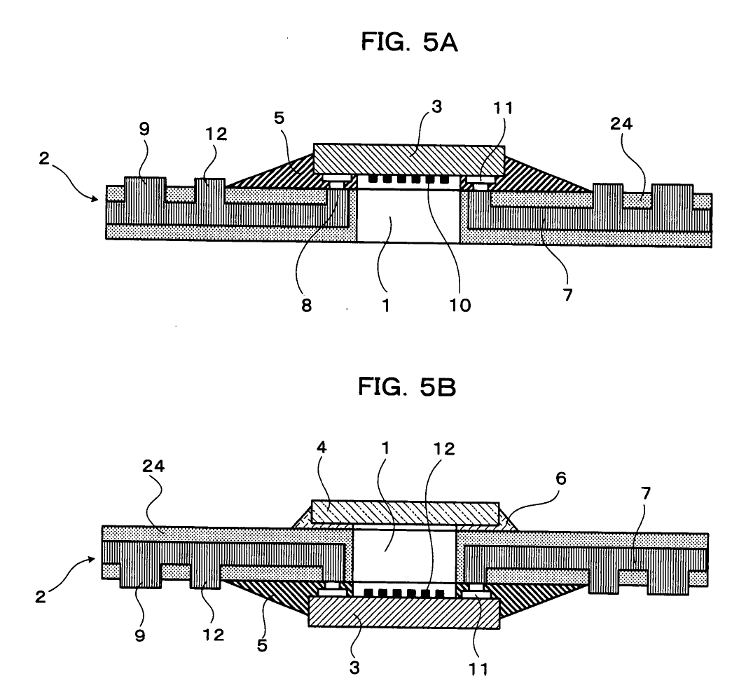

Next, as illustrated in FIG. 5A, the interval of the connection portion between the base 2 and the image sensor 3 and the periphery of the image sensor 3 are filled and covered with the sealing resin 5.

Next, as illustrated in FIG. 5B, the base 2 having the image sensor 3 is reversed, the window member 4 made of glass and covering the opening 1 is laid on the surface opposite to the surface of the base 2 on which the image sensor 3 is mounted, the sealing resin 6 is filled in the interval between the window member 4 and the base 2, and the opening 1 is sealed by the sealing resin 6.

According to this image sensor device, since the metal exposing portion 12 as well as the external terminal portion 9 is exposed, the exposure area of the metal wiring 7 having good heat radiation on the base 2 increases and thus high heat radiation characteristics can be obtained. Accordingly, it is possible to obtain sufficient heat radiation characteristics in an electronic device or an image sensor which requires high heat radiation.

In addition, since the protrusion surfaces of the metal exposing portion 12 and the external terminal portion 9 are substantially in the same plane, the metal exposing portion 12 can be used as a mounting reinforcement portion of the external terminal portion 9. Accordingly, it is possible to easily improve the mounting reliability when the image sensor device is mounted on an electronic device or the like.

Moreover, when the sealing resin 5 which will be filled and covered between the image sensor 3 and the base 2 is coated, even in a case where a low molecular component contained in the sealing resin 5 is leaked and spread, that is, a bleed phenomenon occurs and thus the component flows from the sealing resin 5 along the upper surface of the base 2, it is possible to prevent the bled component from covering the external terminal portion 9, because the metal exposing portion 12 is protruded from the surface of the base 2 and thus functions as a breakwater. By this structure, although a solder ball is not mounted on the external terminal portion like the conventional image sensor device, it is possible to prevent the bled component from covering the external terminal portion 9 and to prevent the mounting yield or the mounting reliability from being reduced when mounting the image sensor device on an electronic device. Accordingly, it is possible to suppress the image sensor device from being enlarged due to the bleed phenomenon, to easily realize the miniaturization and the slimness of the image sensor device, and to obtain good mounting yield and mounting reliability.

Although, in the present embodiment, the shape of the metal exposing portion 12 is rectangular, the present invention is not limited to this and a circular, square metal exposing portion or the like may be used.

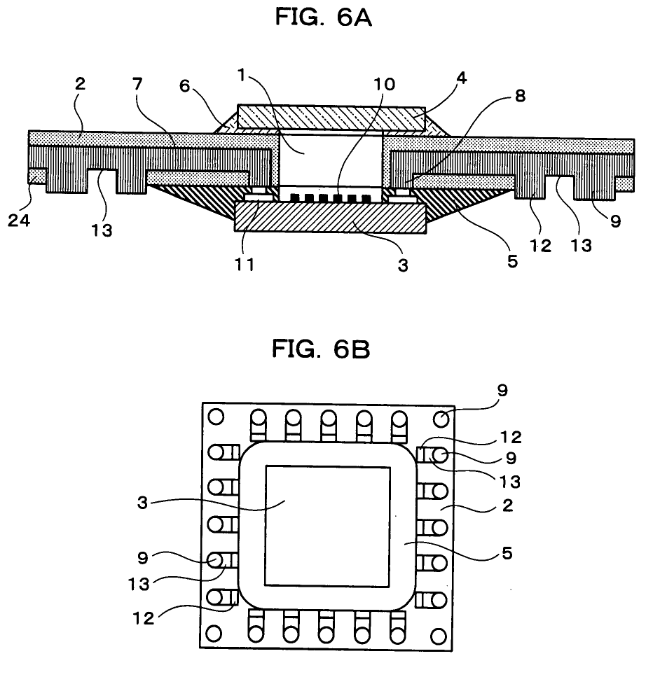

Next, an image sensor device according to a second embodiment of the present invention will be described. FIG. FIG. 6A is a cross-sectional view of an image sensor device according to the second embodiment of the present invention and FIG. 6B is a bottom view of the image sensor device.

As illustrated in FIGS. 6A and 6B, the image sensor device according to the second embodiment is different from the image sensor device according to the first embodiment in that the surface of the connection portion 13 for connecting the external terminal portion 9 with the metal exposing portion 12 in the metal wiring 7 is not covered with the mold resin 24 and is exposed from the surface of the base 2. In the present embodiment, the surface (section) of the metal exposing portion 12 and the surface (section) of the external terminal portion 9 are in the same plane (have the same height) and the metal exposing portion 12 and the external terminal portion 9 are protruded from the surface of the base 2.

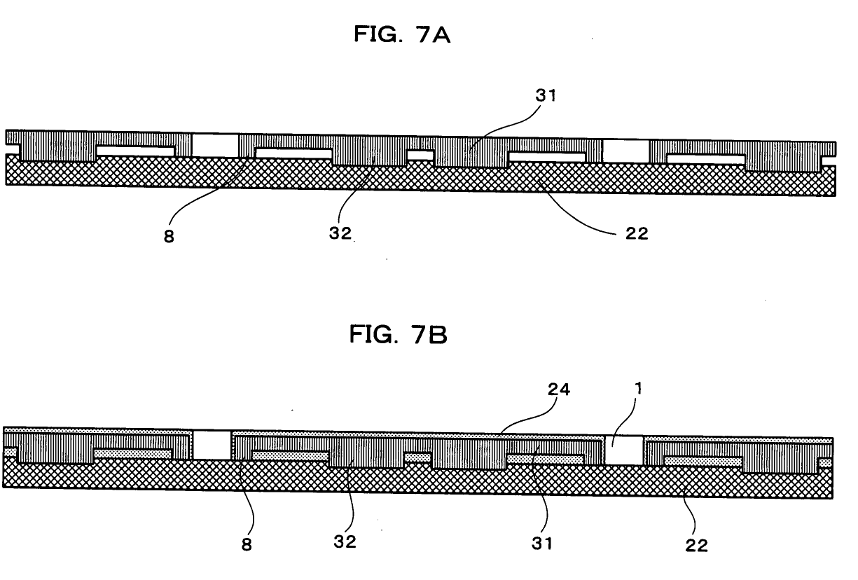

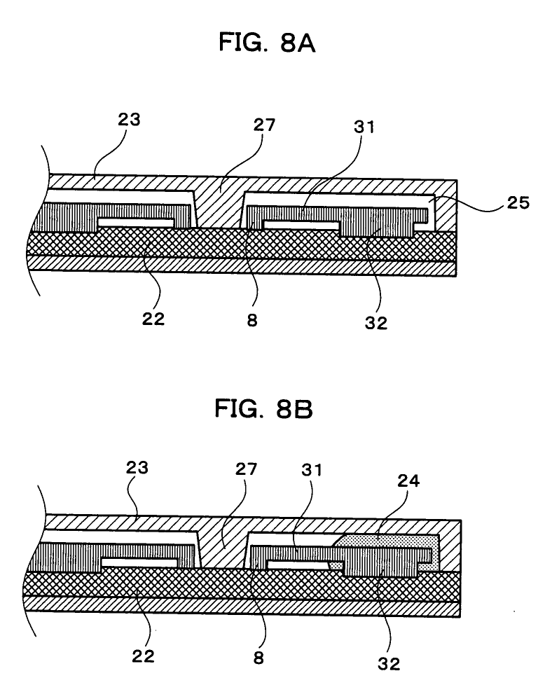

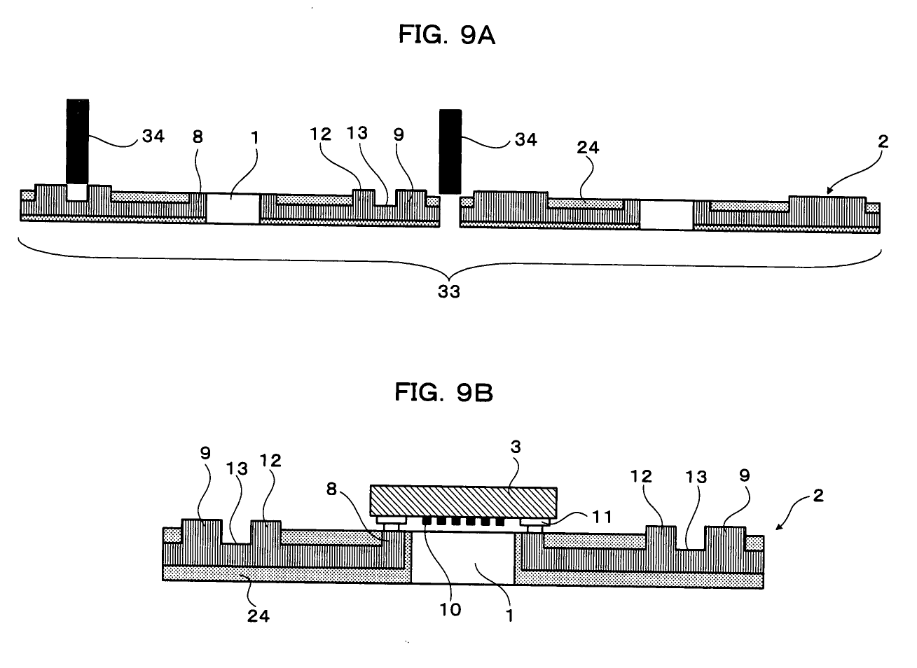

Next, a method of manufacturing the image sensor device will be described with reference to the accompanying drawings. FIGS. 7A, 7B, 9A, 9B, 10A, and 10B are partial cross-sectional views illustrating respective steps in the method of manufacturing the image sensor device. But, although, in the steps illustrated in FIGS. 7A, 7B, and 9A, only a region for forming two image sensor devices is illustrated, the manufacturing method is generally performed using a lead frame 31 in which a plurality of image sensor devices are provided in a grid shape. In addition, FIGS. 8A and 8B are cross-sectional views illustrating a molding step in the method of manufacturing the image sensor device.

First, as shown in FIG. 7A, the lead frame 31, in which a wiring pattern is formed, is laid on a sealing tape 22. The lower surface of the lead frame 31 is provided with concave portions by half etch or press and only portions, which will become a metal exposing region 32 located at a peripheral portion of an image sensor device forming region and an internal terminal portion 8, are protruded downward from the bottom surface of the concave portions. In addition, the metal exposing region 32 is more protruded than the internal terminal portion 8 downward and the lead frame is laid on the sealing tape 22 by weighting so that a difference in a protrusion distance between the internal terminal portion 8 and the metal exposing region 32 is absorbed using deformation in a thickness direction of the sealing tape 22.

Next, in the step illustrated in FIG. 7B, a molding step is performed. In other words, as illustrated in FIGS. 8A and 8B, the lead frame 31 attached to the sealing tape 22 is mounted on a mold die 23 and mold resin 24 such as epoxy resin is filled in a die cavity 25 of the mold die 23 to embed the mold resin 24 in portions except the internal terminal portion 8 and the metal exposing region 32 of the lead frame 31, thereby forming a molded product 33. Since the mold die 23 is formed with a barrier portion 27 for discriminating between cavities and the barrier portion 27 is not filled with the mold resin 24, the center of the image sensor device forming region of the molded product 33 is formed with the opening 1, in the vicinity of which the image sensor 3 will be attached.

Next, as illustrated in FIG. 9A, the sealing tape 22 is stripped from the molded product 33 and the barrier portion between the adjacent image sensor device forming regions of the molded product 33 is then cut by a blade (cut jig) 34, thereby forming the base 2 of the image sensor device from the molded product 33. At this time, the image sensor device forming region exposed from the base 2 is positioned to have a needed size of an external terminal portion 9 and cut by a half to form a dent using the same blade 34 used when dividing the molded product 33 into a plurality of pieces, thereby forming the exposure surfaces of the external terminal portion 9, the metal exposing portion 12, and the connection portion 13 therebetween. At this time, the internal terminal portion 8, the metal exposing portion 12, and the external terminal portion 9 are exposed from the surface of the base 2 and the surface of the connection portion 13 for connecting the metal exposing portion 12 with the external terminal portion 9 is also exposed. In addition, the other portions of the metal wiring 7 are embedded in the base 2.

Next, as illustrated in FIG. 9B, the image sensor 3 is mounted on the base 2 in the state that its light receiving region 10 is downward. At this time, the electrode pad on the image sensor 3 is provided with a bump 11 and the bump 11 is connected to the internal terminal portion 8 on the corresponding base 2.

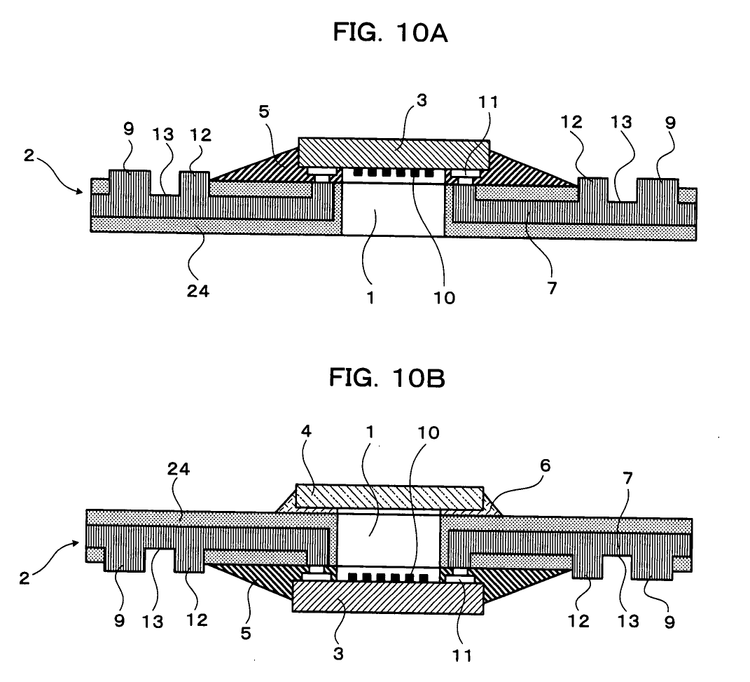

Next, as illustrated in FIG. 10A, an interval of the connection portion between the base 2 and the image sensor 3 and the periphery of the image sensor 3 are filled and covered with the sealing resin 5.

Next, as illustrated in FIG. 10B, the base 2 having the image sensor 3 is reversed, the window member 4 made of glass and covering the opening 1 is laid on the surface opposite to the surface of the base 2 on which the image sensor 3 is mounted, sealing resin 6 is filled in an interval between the window member 4 and the base 2, and the opening 1 is sealed by the sealing resin 6.

According to this image sensor device, since the connection portion 13 as well as the metal exposing portion 12 and the external terminal portion 9 is exposed from the surface of the base 2, the exposure area of the metal wiring 7 having good heat radiation on the surface of the base 2 increases and thus higher heat radiation characteristics can be obtained. In addition, since the protrusion surfaces of the metal exposing portion 12 and the external terminal portion 9 are substantially in the same plane, the metal exposing portion 12 can be used as a mounting reinforcement portion of the external terminal portion 9 and thus it is possible to easily improve mounting reliability when the image sensor device is mounted on an electronic device.

Moreover, in the present embodiment, when the sealing resin 5 which will be filled and covered between the image sensor 3 and the base 2 is coated, even in a case where a low molecular component contained in the sealing resin 5 is leaked and spread, that is, a bleed phenomenon occurs, it is possible to prevent the bled component from covering the external terminal portion 9, because the external terminal portion 9 and the metal exposing portion 12 are protruded from the surface of the base 2 and the metal exposing portion 12 functions as a breakwater. By this structure, although a solder ball is not mounted on the external terminal portion like the conventional image sensor device, it is possible to prevent the bled component from covering the external terminal portion 9 and to prevent the mounting yield or the mounting reliability from being reduced when mounting the image sensor device on an electronic device. Accordingly, it is possible to suppress the image sensor device from being enlarged due to the bleed phenomenon, to easily realize miniaturization and slimness of the image sensor device, and to obtain good mounting yield and mounting reliability.

Although, in the present embodiment, the shape of the metal exposing portion 12 is rectangular, the present invention is not limited to this and a circular or square metal exposing portion may be used.

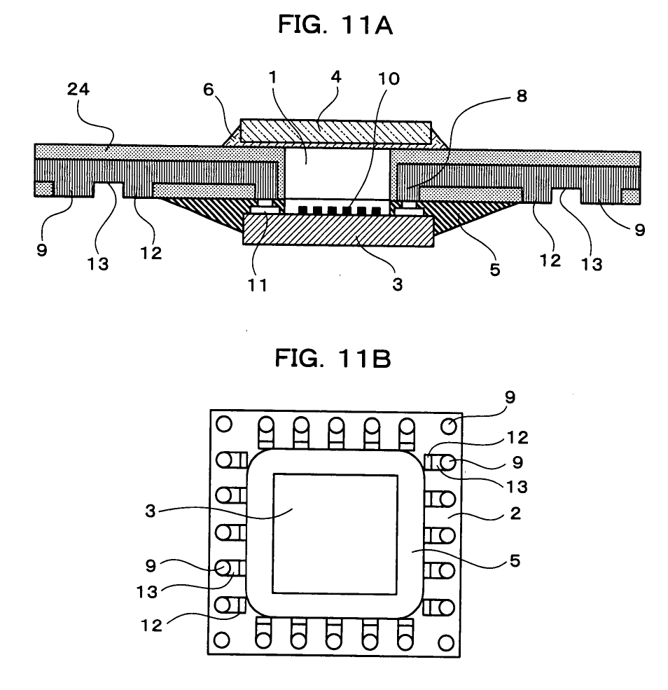

In addition, although, in the image sensor device according to the second embodiment, the surface of the connection portion 13 for connecting the external terminal portion 9 with the metal exposing portion 12 in the metal wiring 7 is not covered by the mold resin 24 and is exposed from the surface of the base 2 and the metal exposing portion 12 and the external terminal portion 9 are protruded from the surface of the base 2, the present invention is not limited to this embodiment and the surfaces of the metal exposing portion 12 and the external terminal portion 9 and the surface of the base 2 may be substantially in the same plane, as illustrated in FIGS. 11A and 11B. In other words, if the surface of the connection portion 13 for connecting the external terminal portion 9 with the metal exposing portion 12 in the metal wiring 7 is not covered by the mold resin 24, although the external terminal portion 9 and the metal exposing portion 12 in the metal wiring 7 are substantially in the same plane as the surface of the base 2 made of the insulating material, a concave dam is formed between the external terminal portion 9 and the metal exposing portion 12 by the connection portion 13 for connecting the external terminal portion 9 with the metal exposing portion 12 and thus it is possible to suppress the bleed phenomenon.

In addition, although, in the respective embodiments, only one metal exposing portion 12 is provided between the internal terminal portion 8 and the external terminal portion 9, the present invention is not limited to these embodiments and a plurality of metal exposing portions 12 may be provided between the internal terminal portion 8 and the external terminal portion 9. For example, by performing the half-cutting step using the blade 34 in plural, it is possible to form a plurality of metal exposing portions 12. Accordingly, it is possible to more increase the area of the metal wiring 7 which is exposed from the base 2 and to obtain better heat radiation characteristics.

What is claimed is:

1. An image sensor device comprising:
a base made of an insulating material and having an opening inside thereof;
a metal wiring embedded in the base;
an internal terminal portion formed in the metal wiring to be exposed from one surface of the base in proximity to the opening;
an external terminal portion formed in the metal wiring to be exposed from the one surface of the base in proximity to an outer circumference thereof;
an image sensor having a light receiving region and mounted on the one surface of the base to be connected to the internal terminal portion so that the light receiving region faces the opening;
sealing resin filled in and covering the periphery of the image sensor and an interval between the image sensor and the base; and
a window member attached to the other surface of the base and having light transmission,
wherein the metal wiring is formed with a metal exposing portion exposed from the one surface of the base between the internal terminal portion and the external terminal portion.

2. The image sensor device according to claim 1, wherein the external terminal portion and the metal exposing portion are protruded from the one surface of the base.

3. The image sensor device according to claim 1, wherein the exposure surfaces of the external terminal portion and the metal exposing portion are substantially in a same plane.

4. The image sensor device according to claim 1, wherein a connection portion connecting the external terminal portion with the metal exposing portion in the metal wiring is exposed from a surface of the base.

5. The image sensor device according to claim 4, wherein the exposure surfaces of the external terminal portion and the metal exposing portion in the metal wiring are substantially in a same plane as the one surface of the base.

6. A method of manufacturing an image sensor device comprising:
a step of using a pair of molds having cavities for forming a plurality of bases with resin, a metal thin lead formed with a plurality of sets of metal wirings each having, in correspondence with the plurality of bases, an internal terminal portion, an external terminal portion, and a metal exposing portion therebetween, and a tape material including the metal thin lead, thereby to load the tape material between the pair of molds so that the sets of metal thin leads are arranged in regions corresponding to the plurality of bases in the cavities, and filling and curing sealing resin in the cavities thereby to form a molded product having a plurality of image sensor device forming regions corresponding to the bases respectively surrounding openings and the metal wirings having the internal terminal portion, the external terminal portion, and the metal exposing portion formed in each of the image sensor device forming regions;
a step of dividing the molded product into a plurality of pieces;
a step of mounting an image sensor at a side of the internal terminal portion comprised of the metal wirings of the molded product;
a step of filling and covering sealing resin in a periphery of the image sensor and an interval between the image sensor and the molded product; and
a step of attaching a window member made of a light transmitting material to the molded product at a surface opposite to a surface mounted with the image sensor.

7. The method according to claim 6, wherein the metal thin lead is arranged so that a thickness difference among the internal terminal portion, the external terminal portion, and the metal exposing portion in the metal wiring formed of the metal thin lead is absorbed by utilizing deformation in a thickness direction of the tape material, and the sealing resin is filled in each of the cavities and cured.

8. A method of manufacturing an image sensor device comprising:
a step of using a pair of molds having cavities for forming a plurality of bases with resin, a metal thin lead formed with a plurality of sets of metal wirings each having, in correspondence with the plurality of bases, an internal terminal portion and a metal exposing region formed at a location closer to an outer periphery of the metal wirings than the internal terminal portion, and a tape material including the metal thin lead forming the plurality of sets of metal wirings corresponding to the plurality of bases, thereby to load the tape material between the pair of molds so that the sets of metal thin leads are arranged in regions corresponding to the plurality of bases in the cavities, and filling and curing sealing resin in the cavities thereby to form a molded product having a plurality of image sensor device forming regions corresponding to the bases respectively surrounding openings, and the internal terminal portion and the metal wirings in each of the image sensor device forming regions, each metal wiring having the metal exposing region formed to locate at a peripheral portion of the image sensor device forming regions;
a step of dividing the molded product into a plurality of pieces by using a cutting tool;
a step of mounting an image sensor at a side of the internal terminal portion composed by each of the metal wirings of the molded product;
a step of filling and covering sealing resin in the periphery of the image sensor and an interval between the image sensor and the molded product; and
a step of attaching a window member made of a light transmission material to the molded product at a surface opposite to a surface of the molded product mounted with the image sensor,
wherein the metal exposing region in the metal wirings is cut into halves with the cutting tool for use in dividing the molded product into a plurality of pieces, whereby an external terminal portion and a metal exposing portion are formed in the metal wirings.
